(19) United States
(12) Patent Application Publication
(10) Pub. No.: US 2014/0272662 A1
(43) Pub. Date: Sep. 18, 2014

(54) CELL RETENTION DESIGN AND PROCESS

(71) Applicant: GM GLOBAL TECHNOLOGY OPERATIONS LLC, (US)

(72) Inventors: Jeffrey A. Rock, Rochester Hills, MI (US); David A. Martinchek, Spencerport, NY (US)

(73) Assignee: GM GLOBAL TECHNOLOGY OPERATIONS LLC, Detroit, MI (US)

(21) Appl. No.: 13/803,098

(22) Filed: Mar. 14, 2013

(51) Int. Cl. H01M 2/10

(52) U.S. Cl. CPC H01M 2/1072
USPC 429/468

(57) ABSTRACT

A system and method for reducing the relative movement between adjacent fuel cells within a fuel cell stack includes an improved strategy for distributing an acceleration load over a fuel cell stack while maintaining stack performance after exposure to high acceleration loads. The system comprises a fuel cell stack comprising a plurality of fuel cells enclosed by a housing. A curable material occupies at least a portion of a lateral space located between the edges of each fuel cell in the stack and an interior wall of the housing. Upon occurrence of high acceleration loads within the housing, the curable material transmits the acceleration load from the housing to more evenly distribute the load to the edges of the fuel cells. A plurality of dams may be secured between the housing and the fuel cell stack forming channels for receiving the curable material.

### BACKGROUND OF THE INVENTION

The present disclosure relates generally to an improved strategy for distributing an acceleration load over a fuel cell stack, and more particularly to a way to improve fuel cell systems to secure the position of the fuel cells within a fuel cell stack and maintain stack performance after exposure to high acceleration loads.

Fuel cell systems produce electrical energy through the oxidation and reduction of a fuel and an oxidant. Hydrogen, for example, is a very appealing fuel source because it is clean and it can be used to produce electricity efficiently in a fuel cell. The automotive industry has expended significant resources in the development of hydrogen fuel cells as a source of power for vehicles. Vehicles powered by hydrogen fuel cells would be more efficient and would generate fewer emissions than today's vehicles employing internal combustion engines.

In a typical fuel cell system, hydrogen or a hydrogen-rich gas is supplied as a reactant through a flowpath to the anode side of a fuel cell while oxygen (such as in the form of atmospheric oxygen) is supplied as a reactant through a separate flowpath to the cathode side of the fuel cell. Catalysts, typically in the form of a noble metal such as platinum, are placed at the anode and cathode to facilitate the electrochemical conversion of the reactants into electrons and positively charged ions (for the hydrogen) and negatively charged ions (for the oxygen). In one well-known fuel cell form, the anode and cathode may be made from a layer of electrically-conductive gaseous diffusion media (GDM) with the catalysts deposited thereon to form a catalyst coated diffusion media (CCDM). An electrolyte layer (also called an ionomer layer) separates the anode from the cathode to allow the selective passage of ions from the anode to the cathode while simultaneously prohibiting the passage of the generated electrons; instead, the electrons are forced to flow through an external electrically-conductive circuit (such as a load) to perform useful work before recombining with the charged ions at the cathode. The combination of the positively and negatively charged ions at the cathode results in the production of non-polluting water as a by-product of the reaction. In another well-known fuel cell form, the anode and cathode may be formed directly on the electrolyte layer to form a layered structure known as a membrane electrode assembly (MEA).

The proton exchange membrane (PEM) fuel cell has shown particular promise for vehicular and related mobile applications. The electrolyte layer of a PEM fuel cell is a solid proton-transmissive membrane, such as a perfluorosulfonic acid membrane (PFSA) (a commercial example of which is Nafion™). Regardless of whether the above MEA-based approach or CCDM-based approach is employed, the presence of an anode separated from a cathode by an electrolyte layer forms a single PEM fuel cell; many such single cells can be combined to form a fuel cell stack, increasing the power output thereof. Multiple stacks can be coupled together to further increase power output.

Fuel cell stacks placed within vehicles must be able to withstand severe load changes from acceleration and deceleration of the vehicle. In particular, in order to continue to perform after exposure to high acceleration loads during events such as a vehicle crash, the position of the fuel cells that make up the stack must be retained. In the event of high acceleration, deceleration, or impact of the vehicle, a high shearing force may cause sliding between cells of the stack. If the cells near the ends of the stack slide in a direction perpendicular to the cell stacking direction, the cell stack may disassemble. Additionally, a stack that has been prepared for a freeze start often possesses a reduced compressive load for retention as a result of reduced membrane swell and thermal contraction, leaving the cells vulnerable to being displaced by lateral accelerations.

Typically, the fuel cell stack is enclosed in a housing that must be able to accommodate fuel cell expansion and contraction based on changing hydration levels and temperature. Current methods of generating retention forces include friction at the end cells of the entire stack generated by stack compression and friction at the end cells of modules, transmitted to the housing through contact with the module frame. The primary disadvantage of retention with the end cell friction is that it is limited by the compressive load multiplied by the coefficient of friction for the interfaces. Because the surface of the GDM is typically treated with polytetrafluoroethylene (PTFE), the coefficient of friction may be so low as to generate insufficient friction to retain the entire stack during severe accelerations. Using an adhesive to retain only the end cell merely moves the weakness in the retention system to the next cell interface. Using adhesives to bond all the interfaces would prohibit stack disassembly for repair or diagnostic analysis.

This inadequate friction force is addressed in prior art by dividing the stack into a series of short stack modules sharing a common compression system. The frames at the ends of each module can then be externally supported by the housing. The retention force at the end cell of each module is still limited as discussed above. Moreover, while the reduced mass of the module requires proportionally less retention force, the part count and complexity of the system are increased thereby adding cost and mass of the module frames to the system.

### SUMMARY OF THE INVENTION

In accordance with the instant disclosure, an improved strategy for distributing an acceleration load over a fuel cell stack, and a method to secure the position of the fuel cells within a fuel cell stack and maintain stack performance after exposure to high acceleration loads is shown and described.

According to one aspect of the present disclosure, a method for reducing the relative movement between adjacent fuel cells within a fuel cell stack during a disruptive event is described. The method includes configuring a fuel cell system to comprise a fuel cell stack comprising a plurality of fuel cells in an adjacently facing relationship enclosed within a housing such that a lateral space exists between the edges of each fuel cell in the stack and an interior wall of the housing. The method further comprises injecting a curable material into at least a portion of the lateral space to provide a bridge between the edges of the fuel cells and the interior wall. Upon occurrence of a disruptive event within the housing, the curable material works to more evenly distribute the acceleration load by transmitting the load from the housing to the edges of fuel cells.

According to another aspect of the present disclosure, a fuel cell system is described. The fuel cell system includes a fuel cell stack comprising a plurality of fuel cells in an adjacently facing relationship enclosed within a housing such that a lateral space exists between the edges of each fuel cell in the stack and an interior wall of the housing. The system further comprises a curable material contained in at least a portion of the lateral space to provide a bridge between the edges of the fuel cells and the interior wall. Upon occurrence of a disruptive event within the housing, the curable material transmits an acceleration load from the housing to more evenly distribute the acceleration load to the edges of fuel cells.

### BRIEF DESCRIPTION OF THE SEVERAL VIEWS OF THE DRAWINGS

The following detailed description of the preferred embodiments of the present invention can be best understood when read in conjunction with the following drawings, where like structure is indicated with like reference numerals and in which:

FIG. 1 is a perspective cutaway view of a vehicle with a fuel cell propulsion system;

FIG. 2a is a perspective view of a fuel cell housing according to one embodiment of the present invention with the fuel cell stack removed;

FIG. 2b is an exploded, detailed perspective view of the fuel cell housing of FIG. 2a showing the details of a curable material contained within a dam that is disposed on an insulating panel attached to the interior wall of the housing that surrounds the fuel cell stack;

FIG. 3 is an end view of the fuel cell housing of FIGS. 2a and 2b showing the fuel cell stack in place within the housing;

FIG. 4 is a perspective view showing the injection of a curable material through ports disposed through the exterior wall of the housing;

FIG. 5 is a perspective view according to one embodiment of the present disclosure showing a U-shaped dam; and

FIG. 6 is a top view according to one embodiment of the present disclosure showing a dam situated in a corner formed by adjacent housing walls.

### DETAILED DESCRIPTION

The following detailed description and appended drawings describe and illustrate various embodiments of the present disclosure. The description and drawings serve to enable one skilled in the art to make and use the invention, and are not intended to limit the scope of the invention in any manner.

Referring first to FIG. 1, vehicle 2 is shown, according to embodiments shown and described herein. Vehicle 2 (for example, a car, bus, truck, or motorcycle) includes a fuel-cell based propulsion system 100 made up of an electric motor 150 that receives its electric power from a fuel cell stack 200 that includes numerous individual fuel cells 6. The propulsion system 100 may include one or more fuel storage gas vessels 210, 220, as well as power converters or related electronics 300, electrical storage devices (e.g., batteries 310, ultra-capacitors or the like) and controllers that provide control over its operation, and any number of valves, compressors, tubing, temperature regulators, and other ancillary equipment.

Any number of different types of fuel cells 6 may be used to make up the stack 200 of the propulsion system 100; these cells 6 may be of the metal hydride, alkaline, electrogalvanic, or other variants. In one preferred (although not necessary) form, the fuel cells 6 are PEM fuel cells as discussed above. Stack 200 includes multiple such fuel cells 6 combined in series and/or parallel in order to produce a higher voltage and/or current yield. The produced electrical power from propulsion system 100 may then be supplied directly to electric motor 150 or stored within a battery 310, capacitor or related electrical storage device (not shown) for later use by vehicle 2. It will be understood that the fuel cell system shown and described herein may be used for purposes other than motor vehicles.

Referring to FIGS. 2a, b, and 3, a system and method for reducing the relative movement between adjacent fuel cells 6 within a fuel cell stack 200 in vehicles 2 powered by a fuel-cell based propulsion system 100 is shown. Severe load changes due to a disruptive event, which includes high acceleration or deceleration of the vehicle 2, an impact involving the vehicle 2, or similar impact to the fuel cell stack 200 itself, such as a vertical fall, can damage the fuel cell stack 200 or disassemble the stack 200 by causing the individual fuel cells 6 to move relative to one another. The likelihood of damage is heightened when a fuel-cell based propulsion system 100 has been prepared for a freeze start due to reduced or minimal compressive load between adjacent fuel cells 6 that in turn produce concomitant reduction in surface friction. To protect against such movement or damage, a system and method for improved distribution of acceleration load is shown and described. The system comprises a fuel cell stack 200 comprising a plurality of fuel cells 6 in an adjacently facing relationship enclosed by a housing 8. A lateral space 10, also known as an air gap, is located between the edges of each fuel cell 6 in the stack 200 and an interior wall 12 of the housing 8. A curable material 14 occupies at least a portion of the lateral space 10 and provides a bridge between the edges of the fuel cells 6 and the interior wall 12 of the housing 8 giving structural support to the fuel cell stack 200. The curable material 14 may either be expandable or may possesses a high lateral stiffness such that the curable material 14 resists flexing laterally when a load is applied in that direction. During repairs, the spacing between the fuel cells 6 of the fuel cell stack 200 increases as the diffusion media decompresses; an expandable curable material 14 allows the fuel cells 6 to expand in both its through-the-thickness dimension, as well as through its edgewise dimension, and then be recompressed without damage to the fuel cells 6 or other components of the fuel-cell based propulsion system 100. Alternatively, when a high stiffness curable material 14 is used, the edges of the fuel cells 6 must flex to accommodate the increase in fuel cell stack 200 length. The curable material 14 may be a foam, liquid, gel, or epoxy. Upon an occurrence of the disruptive event within the housing 8, the curable material 14 transmits an acceleration load from the housing 8 to more evenly distribute the load to the edges of the fuel cells 6. The curable material 14 facilitates even distribution of the load despite differing tolerances of the many components of the fuel cell system and protects the fuel-cell based propulsion system 100. The curable material 14 provides support during a disruptive event, even when the car is parked and the stack is not running, and can either be attached to or restrained by the housing 8. It will be understood that the system and method as shown and described protects against movement or damage to the fuel cell stack 200 in any direction of compression of the fuel cell stack 200 in relation to the orientation of the vehicle.

The lateral space 10 accommodates the hydration and thermal expansion needs of the stack 200 and further makes the stack more accessible for repairs. The lateral space 10 increases when a fuel-cell based propulsion system has been prepared for freeze starts because the elimination of water in the stack 200 to avoid freezing of the fuel cell stack results in the contraction of the GDM between individual fuel cells 6.

According to another aspect of the present disclosure, a plurality of dams 16, which may be composed of a thermoset foam such as polyurethane, a thermoplastic foam such as polystyrene, or flexible cross section as used in bulb seals, are secured between the housing 8 and the fuel cell stack 200, wherein the plurality of dams 16 form channels for receiving the curable material 14. The dams 16 may occupy the entire area defined by the size of the interior wall 12 of the housing 8, may occupy a plurality of small areas, or any area in-between. The plurality of dams 16 may be secured to the housing 8 or to an intermediate material between the housing 8 and the fuel cell stack 200. The intermediate material may be an insulating panel 18 affixed to the interior wall 12 of the housing 8. The plurality of dams 16 may be situated perpendicular to the orientation of the fuel cell stack 200 or situated parallel to the stack 200 orientation and may vary in number and size. The insulating panel 18 serves to disrupt buoyancy convention flow between the fuel cell stack 200 and the housing 8 by minimizing the lateral space 10. The insulating panel 18 also provides electrical insulation. The dams 16 may also be composed of other materials such as, but not limited to, non-structural elastomeric materials, low durometer foams able to fill between cells (˜1 mm gap) to form an adequate seal to contain the material being applied, or any other structural material that may be applied in a state that allows for sealing between cells.

According to another aspect of the present disclosure, a method of reducing the relative movement between adjacent fuel cells 6 within a fuel cell stack 200 during a disruptive event is disclosed. The method includes configuring a fuel cell-based propulsion system 100 as described above and injecting the curable material 14 into at least a portion of the lateral space 10 to provide a bridge between the edges of the fuel cells 6 and the interior walls 12 of the housing 8. The housing 8 comprises a plurality of injection ports 20 for receiving the curable material 14. Once the system 100 is fully assembled, the curable material 14 is injected into the lateral space 10 between the interior walls 12 of the housing 8 and the fuel cell stack 200 via the plurality of injection ports 20. In embodiments including dams 16, the injection ports 20 are in fluid communication with the dams 16. The method further comprises controlling the amount, extent, and curing of the curable material 14 wherein the curable material 14 is viscous enough to allow complete fill without leakage and curing of the material 14 can occur in process without off-line dwell time. Curing can be accomplished at room temperature with two-part mixing systems such as epoxies, or with single component systems at elevated temperature. Alternatively, moisture curing systems such as room temperature vulcanizing (RTV) silicone can be used.

According to another aspect of the present disclosure, the curable material 14 possesses certain other properties, including thermal insulating properties, electrical insulating properties, elastomeric properties, flowability properties, mechanical properties (i.e., stiffness, compliance, modulus of elasticity, strength, etc.) or the like. The thermal insulating properties must be sufficient to limit heat loss from the stack. The electrical insulating properties must be sufficient to avoid excessive shunt currents between the neighboring plates. The elastic properties must be adequate to allow expansion or plate flexure during decompression. The flowability must be sufficient to allow the material to penetrate the gaps between the cells to generate intimate contact, yet not escape from the dammed area. The mechanical properties must be sufficient to carry the maximum acceleration loads. In one exemplary form, the curable material 14 possesses an electrical resistivity of 1.3×10¹⁴ ohms-cm; a viscosity of 30,000 cps; a compressibility of 90 Shore A; a shear strength of between 1250-4500 psi; a coefficient of thermal expansion of between 85-147×10⁻⁶ in/° C.; and a thermal conductivity of 0.104 btu-ft/ft²-hr-° F.

In one embodiment of the present disclosure, as shown in FIG. 4, using an injector 24, the curable material 14 is injected into the lateral space 10 as a liquid that then solidifies into a structural material. The curable material 14 should possess a low enough viscosity to allow the material 14 to flow between the fuel cells 6 but be viscous enough to not spill beyond the lateral space 10. A release agent or a low surface energy material may be used on the insulating panel 18 if bonding to the insulating panel 18 is undesirable.

According to another aspect of the present disclosure, the method further comprises a release liner 22, shown in FIGS. 2a and b, situated between the curable material 14 and an intermediate component (either the housing 8 or the insulating panel 18) so that the system may be disengaged for stack 200 decompression and recompression associated with repairs.

An alternative embodiment of the present invention is shown in FIG. 5, which includes U-shaped dams 16 that are loaded directly into the lateral space 10 once the fuel-cell based propulsion system 100 is assembled as described above. The open portion of the U-shaped dam 16 is oriented upward to allow very flowable materials to be poured into place. An injection molded filler block can then be placed into the uncured material to provide an improved thermal barrier and transmit the mechanical loads to the housing.

Another alternative embodiment of the present invention is shown in FIG. 6, which includes dams 16 for containing curable material 14 installed within the lateral space 10 across the corners created by adjoining interior walls 12 of the housing 8 as described above. In this embodiment, the dam 16 is filled with material before being brought into contact with the fuel cell stack 200.

Another alternative embodiment of the present disclosure includes a pre-formed drop-in insulating panel 18 which may be installed in the lateral space 10 once the fuel-cell based propulsion system 100 is assembled as described above.

While certain representative embodiments and details have been shown for purposes of illustrating the invention, it will be apparent to those skilled in the art that various changes may be made without departing from the scope of the invention, which is defined in the appended claims.

What is claimed is:

1. A method for reducing the relative movement between adjacent fuel cells within a fuel cell stack during a disruptive event, the method comprising:
configuring a fuel cell system to comprise:
a fuel cell stack comprising a plurality of fuel cells in an adjacently facing relationship; and
a housing enclosing the fuel cell stack such that a lateral space is defined between the edges of each fuel cell in the stack and an interior wall of the housing; and
injecting a curable material into at least a portion of the lateral space to provide a bridge
between the edges of the fuel cells and the interior wall such that upon an occurrence of the disruptive event within the housing, the curable material transmits an acceleration load from the housing in such a manner to more evenly distribute the load to the edges of fuel cells.

2. The method of claim 1, further comprising injecting the curable material into the lateral space through a plurality of injection ports located in the housing.

3. The method of claim 1, wherein a plurality of dams are secured between the housing and the fuel cell stack, wherein the plurality of dams form channels for receiving the curable material.

4. The method of claim 3, wherein the plurality of dams are comprised of foam.

5. The method of claim 3 wherein the plurality of dams are secured to the housing.

6. The method of claim 3 wherein the plurality of dams are situated perpendicular to the stack orientation or are situated parallel to the stack orientation.

7. The method of claim 1, wherein the curable material is expandable.

8. The method of claim 1, wherein the curable material possesses a high lateral stiffness.

9. The method of claim 1, wherein the curable material is any one of foam, liquid, or gel.

10. The method of claim 1, further comprising inserting an insulating panel to the interior of the housing such that the insulating panel is situated between the housing and the fuel cell stack.

11. The method of claim 10, wherein a plurality of dams are secured to the insulating panel and wherein the plurality of dams form channels for receiving a curable material.

12. The method of claim 11, wherein the plurality of dams are comprised of foam.

13. A fuel cell system comprising:
a fuel cell stack comprising a plurality of fuel cells in an adjacently facing relationship;
a housing enclosing the fuel cell stack such that a lateral space is defined between the edges of each fuel cell in the stack and an interior wall of the housing; and
a curable material contained in at least a portion of the lateral space wherein the curable material provides a bridge between the edges of the fuel cells and the interior wall such that upon an occurrence of a disruptive event within the housing, the curable material transmits an acceleration load from the housing in such a manner to more evenly distribute the load to the edges of fuel cells.

14. The fuel cell system of claim 13, wherein the housing comprises a plurality of injection ports for receiving the curable material.

15. The fuel cell system of claim 13, wherein a plurality of dams are secured between the housing and the fuel cell stack, wherein the plurality of dams form channels for receiving the curable material.

16. The fuel cell system of claim 15, wherein the plurality of dams are comprised of foam.

17. The fuel cell system of claim 15 wherein the plurality of dams are secured to the housing.

18. The fuel cell system of claim 13, wherein the curable material is expandable.

19. The fuel cell system of claim 13, wherein the curable material possesses a high lateral stiffness.

20. The fuel cell system of claim 13, further comprising an insulating panel situated between the housing and the fuel cell stack.
